(19) United States
(12) Patent Application Publication
(10) Pub. No.: US 2026/0221632 A1
(43) Pub. Date: Jul. 30, 2026

(54) HIGH VOLTAGE RELAY FOR ELECTRIC VEHICLE

(71) Applicant: FCA US LLC, Auburn Hills, MI (US)

(72) Inventors: Zhenqiang Sun, Shanghai (CN); Xiao Ping Mao, Shanghai (CN); RunJie Yang, Shanghai (CN)

(21) Appl. No.: 19/040,985

(22) Filed: Jan. 30, 2025

(51) Int. Cl. H01M 50/583; H01H 50/04; H01H 50/44

(52) U.S. Cl. CPC H01M 50/583; H01H 50/041; H01H 2050/049; H01H 50/44; H01M 2220/20

(57) ABSTRACT

A relay assembly includes a housing defining a contactor compartment and a coil compartment separated by a barrier, a first fixed contactor configured as an input to the relay assembly, a second fixed contactor configured as a first output of the relay assembly, a third fixed contactor configured as a second output of the relay assembly, a fourth fixed contactor disposed within the contactor compartment, a connection busbar configured to establish an electrical connection between the first fixed contactor and the fourth fixed contactor, a first movable contactor assembly configured to selectively electrically connect the first fixed contactor and the second fixed contactor, and a second movable contactor assembly configured to selectively electrically connect the third fixed contactor and the fourth fixed contactor. When the second movable contactor assembly electrically connects the third and fourth fixed contactors, the connection busbar electrically connects the first and third fixed contactors.

### FIELD

The present application relates generally to electrified vehicles and, more particularly, to systems and methods to control high voltage battery operations.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The high voltage battery system includes a battery disconnect unit (BDU) that has individual busbar circuits from the BDU to several high voltage connectors to exterior sections of the high voltage battery pack. These connections are available to control and manage many different device connections in the vehicle. Several busbar circuits within a battery pack require adequate space that presents weight and packaging challenges that add complexity and increase cost. Accordingly, while such conventional systems do work well for their intended purpose, there remains a need for improvement in the relevant art.

### SUMMARY

In accordance with one example aspect of the invention, a relay assembly of a battery disconnect unit (BDU) of an electrified vehicle high voltage (HV) battery system is provided. In one example implementation, the relay assembly includes a housing defining a contactor compartment and a coil compartment separated by a barrier, a first fixed contactor at least partially disposed within the contactor compartment and configured as an input to the relay assembly, a second fixed contactor at least partially disposed within the contactor compartment and configured as a first output of the relay assembly, a third fixed contactor at least partially disposed within the contactor compartment and configured as a second output of the relay assembly, a fourth fixed contactor disposed within the contactor compartment, a connection busbar configured to establish an electrical connection between the first fixed contactor and the fourth fixed contactor, a first movable contactor assembly configured to selectively electrically connect the first fixed contactor and the second fixed contactor, and a second movable contactor assembly configured to selectively electrically connect the third fixed contactor and the fourth fixed contactor. When the second movable contactor assembly electrically connects the third and fourth fixed contactors, the connection busbar electrically connects the third fixed contactor to the first fixed contactor.

In addition to the foregoing, the described relay assembly may include one or more of the following features: a biasing mechanism configured to bias the connection busbar into contact with the first and fourth fixed contactors; wherein the first, second, and third fixed contactors extend through the housing into the contactor compartment; wherein the coil compartment is divided into a first coil compartment and a second coil compartment by a second barrier, wherein the first coil assembly is disposed within the first coil compartment, and wherein the second coil assembly is disposed within the second coil compartment; and wherein the contactor compartment is divided into a first contactor compartment and a second contactor compartment by a third barrier, wherein the first and second fixed contactors are disposed within the first contactor compartment, and wherein the third and fourth fixed contactors are disposed within the second contactor compartment.

In addition to the foregoing, the described relay assembly may include one or more of the following features: wherein the first movable contactor assembly includes a coil assembly, and a movable contactor configured to selectively move into contact with the first and second fixed contactors when the coil assembly is energized; wherein the coil assembly includes a magnetic core with a coil wound thereon, and wherein the movable contactor is coupled to a pin that extends through the barrier and into the coil assembly; wherein the second movable contactor assembly includes a second coil assembly, and a second movable contactor configured to selectively move into contact with the third and fourth fixed contactors when the second coil assembly is energized; and wherein the second coil assembly includes a second magnetic core with a second coil wound thereon, and wherein the second movable contactor is coupled to a second pin that extends through the barrier and into the second coil assembly.

In accordance with another example aspect of the invention, a high voltage (HV) battery system for an electrified vehicle is provided. In one example implementation, the HV battery system includes a HV battery, a HV bus configured to provide power to an electric drive module (EDM), a HV circuit configured to connect to an external charging system, and a battery disconnect unit (BDU) having a relay assembly configured to selectively connect the HV battery to the HV bus or the HV circuit.

In addition to the foregoing, the described HV battery system may include one or more of the following features: wherein the relay assembly includes a housing defining a contactor compartment and a coil compartment separated by a barrier, a first fixed contactor at least partially disposed within the contactor compartment and configured as an input to the relay assembly, a second fixed contactor at least partially disposed within the contactor compartment and configured as a first output of the relay assembly, a third fixed contactor at least partially disposed within the contactor compartment and configured as a second output of the relay assembly, a fourth fixed contactor disposed within the contactor compartment, a connection busbar configured to establish an electrical connection between the first fixed contactor and the fourth fixed contactor, a first movable contactor assembly configured to selectively electrically connect the first fixed contactor and the second fixed contactor, and a second movable contactor assembly configured to selectively electrically connect the third fixed contactor and the fourth fixed contactor. When the second movable contactor assembly electrically connects the third and fourth fixed contactors, the connection busbar electrically connects the third fixed contactor to the first fixed contactor.

In addition to the foregoing, the described HV battery system may include one or more of the following features: wherein the relay assembly further comprises a biasing mechanism configured to bias the connection busbar into contact with the first and fourth fixed contactors; wherein the first, second, and third fixed contactors extend through the housing into the contactor compartment; wherein the coil compartment is divided into a first coil compartment and a second coil compartment by a second barrier, wherein the first coil assembly is disposed within the first coil compartment, and wherein the second coil assembly is disposed within the second coil compartment; and wherein the contactor compartment is divided into a first contactor compartment and a second contactor compartment by a third barrier, wherein the first and second fixed contactors are disposed within the first contactor compartment, and wherein the third and fourth fixed contactors are disposed within the second contactor compartment.

In addition to the foregoing, the described HV battery system may include one or more of the following features: wherein the first movable contactor assembly includes a coil assembly, and a movable contactor configured to selectively move into contact with the first and second fixed contactors when the coil assembly is energized; wherein the coil assembly includes a magnetic core with a coil wound thereon, and wherein the movable contactor is coupled to a pin that extends through the barrier and into the coil assembly; wherein the second movable contactor assembly includes a second coil assembly, and a second movable contactor configured to selectively move into contact with the third and fourth fixed contactors when the second coil assembly is energized; and wherein the second coil assembly includes a second magnetic core with a second coil wound thereon, and wherein the second movable contactor is coupled to a second pin that extends through the barrier and into the second coil assembly.

Further areas of applicability of the teachings of the present application will become apparent from the detailed description, claims and the drawings. It should be understood that the detailed description, including disclosed embodiments and drawings referenced therein, are merely exemplary in nature intended for purposes of illustration only and are not intended to limit the scope of the present application, its application or uses. Thus, variations that do not depart from the gist of the present application are intended to be within the scope of the present application.

### BRIEF DESCRIPTION OF DRAWINGS

FIG. 1 is a functional block diagram of an electrified vehicle having a high voltage battery system in accordance with the principles of the present disclosure;

FIG. 2 is an example circuit diagram of the high voltage battery system with a relay assembly in accordance with the principles of the present disclosure;

FIG. 3 is a side sectional view of the example relay assembly of the high voltage battery system, in accordance with the principles of the present disclosure;

FIG. 4 is a top perspective view of a portion of the relay assembly shown in FIG. 3, in accordance with the principles of the present disclosure; and

FIG. 5 is a bottom perspective view of the relay assembly shown in FIG. 4, in accordance with the principles of the present disclosure.

### DESCRIPTION

As previously discussed, electrified vehicles (EVs) typically include an electrified powertrain with one or more electric traction motors powered by a high voltage (HV) battery system. The HV battery system is selectively connected to a HV bus by a battery disconnect unit (BDU), which typically includes some form of relay, fuse, resistor, and other parts connected via a complex busbar. Additional features, such as a fast charge system, may require multiple (e.g., four) relays. However, this requires a design with complex connections. Thus, such designs require a lot of packaging space, present weight challenges that add assembly complexity, and increase costs.

Accordingly, described herein are systems and methods for a HV battery system BDU having a relay assembly that minimizes packaging volume, simplifies electrical connections, and reduces material usage. In general, the relay assembly includes a dual control circuit function integrated into a single unit. The relay assembly includes a single input from the main HV circuit/bus with dual split outputs. The relay assembly includes two coil rooms to manage the two split outputs and open or close the connections when a signal is received by a battery management system (BMS).

In one example, a first output is selectively connected to the main circuit for connection to the power distribution unit (PDU), the electric drive module (EDM), and/or another HV connector. A second output is selectively connected to a second circuit for a fast charge connection. As such, the relay assembly integrates main bus and fast charge switch function in the circuit to thereby provide an improved layout with minimized material usage.

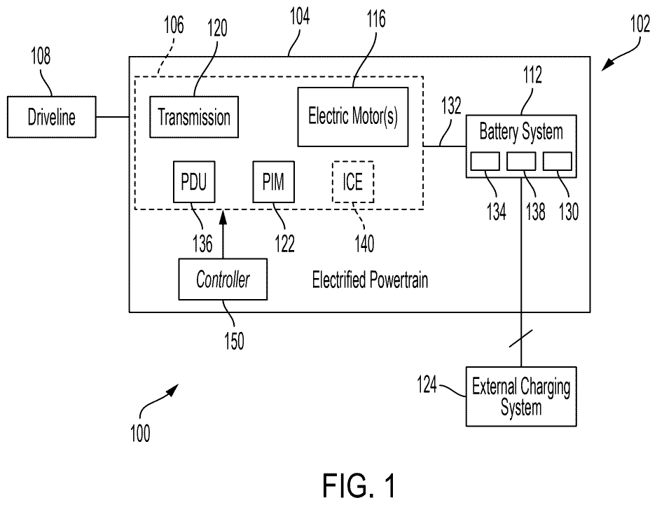

Referring now to FIG. 1, a functional block diagram of an electrified vehicle 100 having an example high voltage (HV) battery control system 102 according to the principles of the present application is illustrated. The vehicle 100 includes an electrified powertrain 104 having one or more electric drive modules (EDMs) 106 configured to generate and transfer drive torque to a driveline 108 for vehicle propulsion. The electrified powertrain 104 is configured to utilize electrical energy from a high voltage battery system 112. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 122 to the high voltage (HV) battery system 112 for powering the electric motor 116. The high voltage battery system 112 is selectively connectable (e.g., by the driver) to an external charging system 124 (also referred to herein as “charger 124”) for charging of the battery system 112. The HV battery system 112 includes at least one battery pack assembly 130 configured to be selectively connected to a HV bus 132 or the charger 124 via a battery disconnect unit (BDU) 134, as described herein in more detail. The HV bus 132 is electrically connected to the EDM 106 and a power distribution unit (PDU) 136, which is configured to provide power to additional HV loads (not shown).

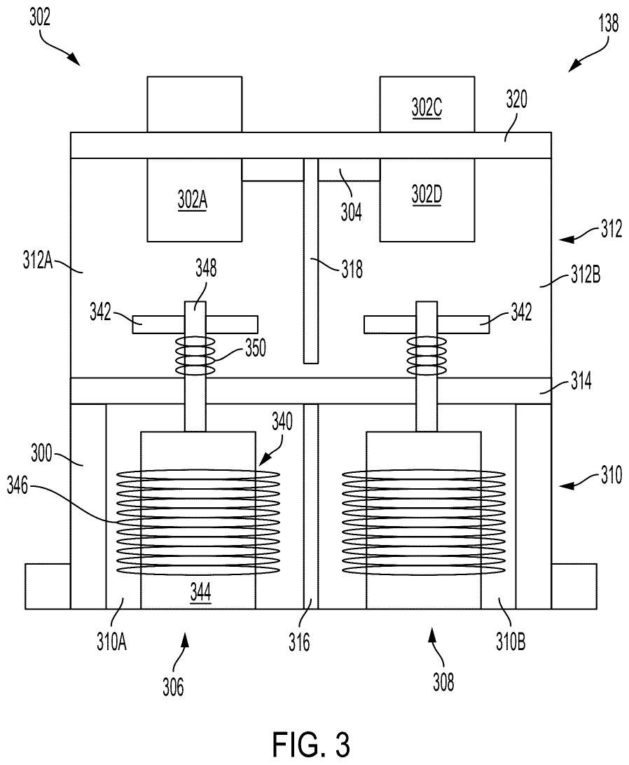

In some examples, the electrified powertrain 104 can be a hybrid powertrain that additionally includes an internal combustion engine 140. A control system or controller 150 is configured to control the electrified powertrain 104 and can provide various inputs to the EDM 106 related to selectively switching power inputs between the electric motors 116 and, optionally, the engine 140. The controller 150 is also configured to control a relay assembly 138 (FIG. 3) of the BDU 134 to selectively connect the HV battery pack assembly 130 to the EDM 106, PDU 136, and charger 124, as described herein in more detail.

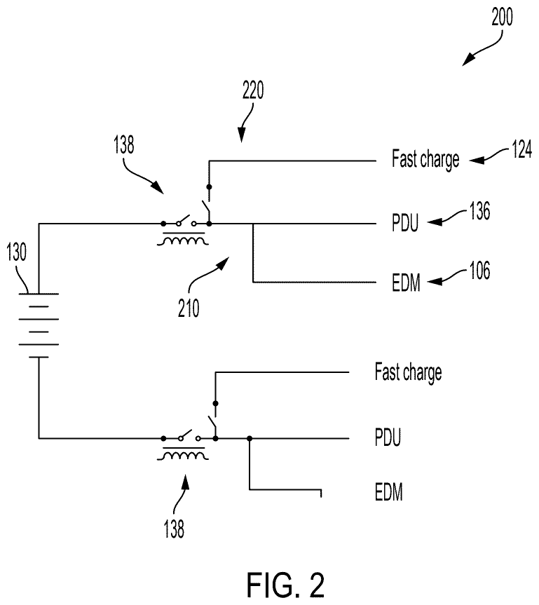

With reference now to FIG. 2, the relay assembly 138 of the BDU 134 will be described in more detail according to the principles of the present application. FIG. 2 illustrates the relay assembly 138 in a circuit 200 for selectively connecting the HV battery pack assembly 130 to a main circuit 210 or a secondary circuit 220. The main circuit 210 (e.g., HV bus 132) is configured to provide power to the EDM 106 and PDU 136 (for powering additional HV loads). The secondary circuit 220 is configured to connect to the external charging system 124, for example, for a fast-charging operation of the HV battery pack assembly 130. As described herein in more detail. The relay assembly 138 is a single unit that enables selective switching between the main circuit 210 and the secondary circuit 220.

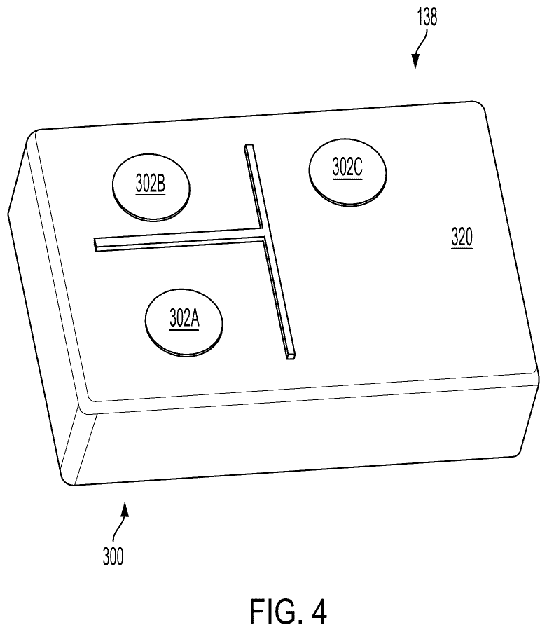

Referring now to FIGS. 3-5, an example embodiment of the relay assembly 138 is illustrated according to the principles of the present application. In the example embodiment, the relay assembly 138 generally includes a housing 300, a plurality of fixed electrical contactors collectively identified at 302, a connection busbar 304, and a pair of movable contactor assemblies 306, 308. The housing 300 generally defines a coil compartment 310 and a contactor compartment 312 separated by a first wall or barrier 314. In one example, the coil compartment 310 may be made of a plastic material, and the contactor compartment 312 may be made of a ceramic material. Additionally, the coil compartment 310 is further separated into a first coil compartment 310A and a second coil compartment 310B by a second wall or barrier 316. Similarly, the contactor compartment 312 is further separated into a first contactor compartment 312A and a second contactor compartment 312B by a third wall or barrier 318.

In the example embodiment, the collective fixed contactors 302 include four fixed contactors 302A-D. The first fixed contactor 302A extends through a top wall 320 and is configured as an input contactor. The second fixed contactor 302B extends through the top wall 320 and is configured as a first output contactor configured to electrically couple to the main circuit 210 (e.g., HV bus 132) with the EDM 106 and PDU 136. The third fixed contactor 302C extends through the top wall 320 and is configured as a second output contactor configured to electrically couple to the secondary circuit 220 for connection with the external charging system 124. The fourth fixed contactor 302D is coupled to an interior surface of the top wall 320 within the contactor compartment 312. The fourth fixed contactor 302D is configured to act as an intermediary connection between the first fixed contactor 302A and the third fixed contactor 302C.

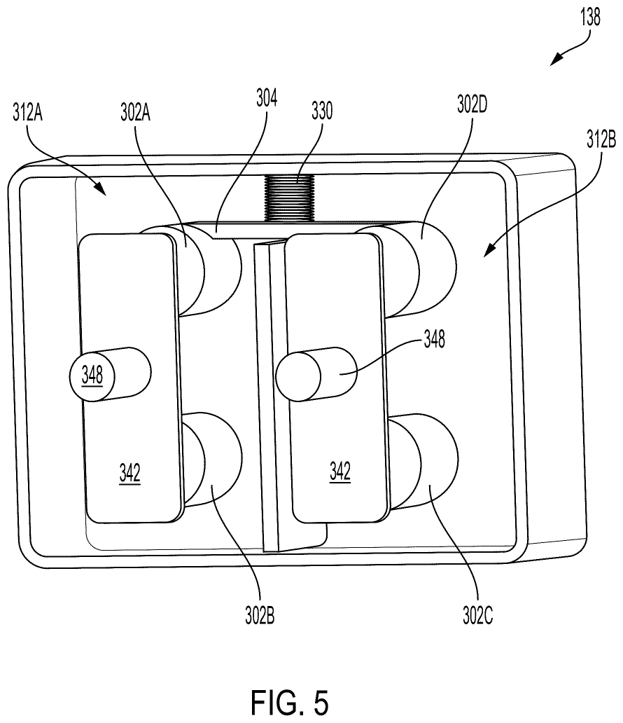

In the example embodiment, the connection busbar 304 includes a biasing mechanism 330 (FIG. 5), for example a spring, configured to force the connection busbar 304 into contact with the first fixed contactor 302A and the fourth fixed contactor 302D to establish an electrical connection therebetween. The biasing mechanism 330 may be coupled to an interior surface of the housing 300 and the connection busbar 304 by any suitable means.

In the example embodiment, the movable contactor assemblies 306, 308 are the same or substantially similar. While movable contactor assembly 306 is described in detail, the features are equally applicable to movable contactor assembly 308 and like reference numerals represent like parts. In the example implementation, the movable contactor assembly 306 generally includes a coil assembly 340 and a movable contactor 342. The coil assembly 340 includes a magnetic core 344 (e.g., ferrite core) and a coil 346 wound thereon. The movable contactor 342 is coupled to a pin or shaft 348, which extends through the first barrier 314, and is operably associated with the coil assembly 340. A biasing mechanism 350 (e.g., a spring) may be coupled to at least one of the first barrier 314, the movable contactor 342, and the shaft 348. The biasing mechanism 350 is configured to bias the movable contactor 342 into a first position (e.g., out of contact with the fixed contactor 302).

In an example operation, a control current (not shown) is provided to coil 346 to create a magnetic field with the magnetic core 344. This magnetic field is configured to push or pull the shaft 348 to move the movable contactor 342 into and out of contact with two of the fixed contactors 302 to selectively establish an electrical connection therebetween. For example, the first movable contactor assembly 306 is configured to selectively establish an electrical connection between the input fixed contactor 302A and the first output fixed contactor 302B. Similarly, the second movable contactor assembly 308 is configured to selectively establish an electrical connection between the second output fixed contactor 302C and the fixed contactor 302D. Because the fixed contactor 302 is electrically coupled to the input fixed contactor 302A via the connection busbar 304, the second output fixed contactor 302C is thus electrically coupled to the input fixed contactor 302A.

Accordingly, the relay assembly 138 is configured to selectively establish an electrical connection between the HV battery pack 130 and either the main circuit 210 for powering the EDM 106 and/or PDU 136, or the secondary circuit 220 for connecting to the external charging system 124. The relay assembly 138 is advantageously a single relay unit, which reduces parts and complexity, and obviates the need for multiple separate relays in the HV battery system 112.

It will be appreciated that the term “controller” or “module” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A relay assembly of a battery disconnect unit (BDU) of an electrified vehicle high voltage (HV) battery system, comprising:
a housing defining a contactor compartment and a coil compartment separated by a barrier;
a first fixed contactor at least partially disposed within the contactor compartment and configured as an input to the relay assembly;
a second fixed contactor at least partially disposed within the contactor compartment and configured as a first output of the relay assembly;
a third fixed contactor at least partially disposed within the contactor compartment and configured as a second output of the relay assembly;
a fourth fixed contactor disposed within the contactor compartment;
a connection busbar configured to establish an electrical connection between the first fixed contactor and the fourth fixed contactor;
a first movable contactor assembly configured to selectively electrically connect the first fixed contactor and the second fixed contactor; and
a second movable contactor assembly configured to selectively electrically connect the third fixed contactor and the fourth fixed contactor,
wherein when the second movable contactor assembly electrically connects the third and fourth fixed contactors, the connection busbar electrically connects the third fixed contactor to the first fixed contactor.

2. The relay assembly of claim 1, further comprising a biasing mechanism configured to bias the connection busbar into contact with the first and fourth fixed contactors.

3. The relay assembly of claim 1, wherein the first, second, and third fixed contactors extend through the housing into the contactor compartment.

4. The relay assembly of claim 1, wherein the coil compartment is divided into a first coil compartment and a second coil compartment by a second barrier,
wherein the first coil assembly is disposed within the first coil compartment, and
wherein the second coil assembly is disposed within the second coil compartment.

5. The relay assembly of claim 4, wherein the contactor compartment is divided into a first contactor compartment and a second contactor compartment by a third barrier,
wherein the first and second fixed contactors are disposed within the first contactor compartment, and
wherein the third and fourth fixed contactors are disposed within the second contactor compartment.

6. The relay assembly of claim 1, wherein the first movable contactor assembly comprises:
a coil assembly; and
a movable contactor configured to selectively move into contact with the first and second fixed contactors when the coil assembly is energized.

7. The relay assembly of claim 6, wherein the coil assembly includes a magnetic core with a coil wound thereon, and
wherein the movable contactor is coupled to a pin that extends through the barrier and into the coil assembly.

8. The relay assembly of claim 7, wherein the second movable contactor assembly comprises:
a second coil assembly; and
a second movable contactor configured to selectively move into contact with the third and fourth fixed contactors when the second coil assembly is energized.

9. The relay assembly of claim 8, wherein the second coil assembly includes a second magnetic core with a second coil wound thereon, and
wherein the second movable contactor is coupled to a second pin that extends through the barrier and into the second coil assembly.

10. A high voltage (HV) battery system for an electrified vehicle, the HV battery system comprising:
a HV battery;
a HV bus configured to provide power to an electric drive module (EDM);
a HV circuit configured to connect to an external charging system; and
a battery disconnect unit (BDU) having a relay assembly configured to selectively connect the HV battery to the HV bus or the HV circuit.

11. The HV battery system of claim 10, wherein the relay assembly comprises:
a housing defining a contactor compartment and a coil compartment separated by a barrier;
a first fixed contactor at least partially disposed within the contactor compartment and configured as an input to the relay assembly;
a second fixed contactor at least partially disposed within the contactor compartment and configured as a first output of the relay assembly;
a third fixed contactor at least partially disposed within the contactor compartment and configured as a second output of the relay assembly;
a fourth fixed contactor disposed within the contactor compartment;
a connection busbar configured to establish an electrical connection between the first fixed contactor and the fourth fixed contactor;
a first movable contactor assembly configured to selectively electrically connect the first fixed contactor and the second fixed contactor; and
a second movable contactor assembly configured to selectively electrically connect the third fixed contactor and the fourth fixed contactor,
wherein when the second movable contactor assembly electrically connects the third and fourth fixed contactors, the connection busbar electrically connects the third fixed contactor to the first fixed contactor.

12. The HV battery system of claim 11, wherein the relay assembly further comprises a biasing mechanism configured to bias the connection busbar into contact with the first and fourth fixed contactors.

13. The HV battery assembly of claim 11, wherein the first, second, and third fixed contactors extend through the housing into the contactor compartment.

14. The HV battery system of claim 11, wherein the coil compartment is divided into a first coil compartment and a second coil compartment by a second barrier,
wherein the first coil assembly is disposed within the first coil compartment, and
wherein the second coil assembly is disposed within the second coil compartment.

15. The HV battery system of claim 14, wherein the contactor compartment is divided into a first contactor compartment and a second contactor compartment by a third barrier,
wherein the first and second fixed contactors are disposed within the first contactor compartment, and
wherein the third and fourth fixed contactors are disposed within the second contactor compartment.

16. The HV battery system of claim 11, wherein the first movable contactor assembly comprises:
a coil assembly; and
a movable contactor configured to selectively move into contact with the first and second fixed contactors when the coil assembly is energized.

17. The HV battery system of claim 16, wherein the coil assembly includes a magnetic core with a coil wound thereon, and
wherein the movable contactor is coupled to a pin that extends through the barrier and into the coil assembly.

18. The HV battery system of claim 17, wherein the second movable contactor assembly comprises:
a second coil assembly; and
a second movable contactor configured to selectively move into contact with the third and fourth fixed contactors when the second coil assembly is energized.

19. The HV battery system of claim 18, wherein the second coil assembly includes a second magnetic core with a second coil wound thereon, and
wherein the second movable contactor is coupled to a second pin that extends through the barrier and into the second coil assembly.
